(19) United States
(12) Patent Application Publication
(10) Pub. No.: US 2011/0291842 A1
(43) Pub. Date: Dec. 1, 2011

(54) APPARATUSES AND METHODS FOR A PHYSIOLOGICAL ALARM

(75) Inventors: Robert D. Oexman, Carthage, MO (US); David B. Scott, Carthage, MO (US)

(73) Assignee: Kingsdown, Inc., Mebane, NC (US)

(21) Appl. No.: 12/990,456

(22) PCT Filed: Nov. 14, 2008
(86) PCT No.: PCT/US08/83629

§ 371 Date: Dec. 29, 2010

Related U.S. Application Data
(60) Provisional application No. 61/049,584, filed on May 1, 2008.

(51) Int. Cl. G08B 23/00

(52) U.S. Cl. 340/575

(57) ABSTRACT

Alarm apparatuses and methods for awakening a person are provided, the apparatus including a data analysis unit; an input unit; and an alarm control unit; wherein the data analysis unit is configured to analyze data related to a state of sleep of a person; wherein the input unit is configured to input data related to a desired awaken period within which the person desires to be awakened; and wherein the alarm control unit is configured to control an alarm for awakening the person using information from the data analysis unit.

### CROSS-REFERENCE TO RELATED PATENT APPLICATION

This application claims priority from U.S. Provisional Patent Application No. 61/049,584, filed on May 1, 2008, in the U.S. Patent and Trademark Office, the disclosure of which is incorporated herein by reference in its entirety.

### BACKGROUND

1. Technical Field

Apparatuses and methods consistent with the present invention relate to a physiological alarm. In particular, these apparatuses and methods relate to awakening a sleeping person based on the person's state of sleep. Further, these apparatuses and methods relate to awakening a sleeping person in lighter states of sleep or non-REM states of sleep using a wide variety of alarm mechanisms so as to provide a better overall awakening experience for the person.

2. Description of the Related Art

Conventional devices for awakening a person, such as alarm clocks, produce an audible alarm at a predetermined time. However, such conventional alarm clocks are problematic since, among other disadvantages, they always awaken a person at a predetermined time regardless of the person's state of sleep.

During a given night, a person experiences numerous variations in sleep state. See e.g., Iber C et al., The AASM Manual for the Scoring of Sleep and Associated Events: Rules, Terminology and Technical Specification, 1^{st} ex.: Westchester, Ill.: American Academy of Sleep Medicine, 2007, which is incorporated herein by reference in its entirety. For example, if a person is in a deep state of sleep (e.g., State N4) when the predetermined alarm time occurs, the conventional alarm clock sounds even though the person is in a deep sleep state and, therefore, awakening may be difficult for the person and the person could experience tiredness and grogginess for several hours after awakening.

On the other hand, if an alarm device were to analyze the person's state of sleep and awaken the person when they are in a lighter state of sleep (e.g., State N1), or when the person is nearly awake, then awakening would be much easier for the person and the possibility of such tiredness or grogginess would be reduced.

Similarly, if a person is in a state of rapid eye movement (REM) sleep, where most dream activity occurs, and a conventional alarm clock awakens the person in the middle of a dream, the person may wake up confused and disoriented. However, if an alarm device were to analyze the person's state of sleep and awaken the person while they are not in a state of REM sleep, then the possibility of awakening the person during a dream would be reduced and such confusion and disorientation during the awakening experience could be avoided.

Thus, there is a need for apparatuses and methods for awakening a person based on the person's state of sleep. There is also a need for apparatuses and methods relate for awakening a sleeping person in lighter states of sleep or non-REM states of sleep using a wide variety of alarm mechanisms so as to provide a better overall awakening experience for the person. Further, there is a need for apparatuses and methods for reminding the person that it is time to awaken while the person is awake or almost awake, rather than waking the person while they are asleep. Moreover, there is a need for apparatuses and methods for awakening a person at an optimal sleep state within a predetermined period during which the person desires to be awakened. There is also a need for using a bed or a pillow to measure quality of sleep and then controlling an alarm using these measurements.

### SUMMARY

Apparatuses and methods for a physiological alarm are described herein. Aspects of the present invention analyze a person's state of sleep and awaken the person using such analysis data. Aspects of the present invention awaken a sleeping person in lighter states of sleep or non-REM states of sleep using a wide variety of alarm mechanisms so as to provide a better overall awakening experience for the person. Further, aspects of the present invention awaken a person at an optimal sleep state within a predetermined period during which the person desires to be awakened.

According to one aspect of the present invention, an alarm apparatus comprises: a data analysis unit; an input unit; and an alarm control unit; wherein the data analysis unit is configured to analyze data related to a state of sleep of a person; wherein the input unit is configured to input data related to a desired awaken period within which the person desires to be awakened; and wherein the alarm control unit is configured to control an alarm for awakening the person using information from the data analysis unit.

According to another aspect of the present invention, a method for awakening a person, the method comprises: inputting a desired awaken period within which the person desires to be awakened; determining whether a current time is within the desired awaken period; if it is determined that the current time is within the desired awaken period, then executing an analysis method comprising: analyzing data relating to the person's state of sleep; determining whether the analyzed data indicates that the person is in a light stage of sleep; if it is determined that the analyzed data indicates that the person is in a light stage of sleep, then initiating an alarm process; if it is determined that the analyzed data does not indicate that the person is in a light stage of sleep, then determining whether the desired awaken period has expired; if it is determined that the desired awaken period has expired, then initiating the alarm process.

### BRIEF DESCRIPTION OF THE DRAWINGS

The above and other aspects of the present invention will become more apparent by describing in detail illustrative embodiments thereof with reference to the attached drawings in which:

FIG. 1 illustrates a schematic view of an apparatus for a physiological alarm according to an illustrative embodiment of the present invention;

FIG. 2 illustrates a cross-sectional view of a variable sleep system employing a variable support and comfort control system according to an illustrative embodiment of the present invention;

FIG. 3 illustrates a sense and control unit according to an illustrative embodiment of the present invention;

FIG. 4 illustrates a view of an inflatable member according to an illustrative embodiment of the present invention;

FIG. 5 illustrates a schematic cross-sectional view of an automatic pillow adjustment system according to an illustrative embodiment of the present invention;

FIG. 6 illustrates a flow chart of a method for a physiological alarm according to an illustrative embodiment of the present invention;

FIG. 7A illustrates a side view of one end of an inflatable member according to an illustrative embodiment of the present invention; and

FIG. 7B illustrates a top view of an inflatable member according to an illustrative embodiment of the present invention.

### DETAILED DESCRIPTION OF ILLUSTRATIVE EMBODIMENTS

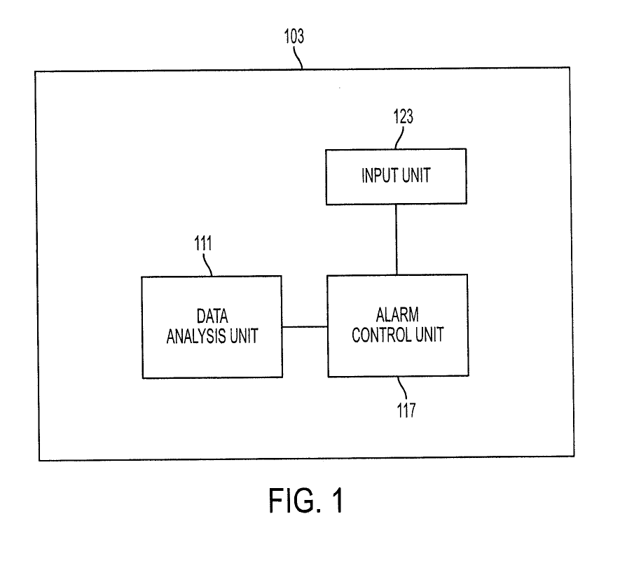

Hereinafter, illustrative embodiments of the present invention will be described in detail with reference to the attached drawings. FIG. 1 illustrates a schematic view of an apparatus for a physiological alarm according to an illustrative embodiment of the present invention. As shown in FIG. 1, physiological alarm unit 103 comprises a data analysis unit 111, an input unit 123 and an alarm control unit 117. The data analysis unit 111 analyzes data related to a person's state of sleep, as discussed in detail below. The alarm control unit 117 controls an alarm for awakening the person using information provided by the data analysis unit 111, as discussed in detail below.

Consistent with the present invention, the physiological alarm unit 103 can be incorporated into a standalone unit disposed in a person's bedroom (e.g., a device disposed on a person's nightstand). More generally, the physiological alarm unit 103 can be integrated into any aspect of the person's sleeping environment including, but not limited to, any aspect of a bedding assembly, mattress, pillow, sheets, comforter, box spring unit, foundation unit, bed frame, mattress pad, linens etc.

The data analysis unit 111 analyzes data relating to a person's state of sleep that can be collected in a wide variety of ways using a wide variety of collection devices, examples of which are discussed in detail below. According to an illustrative embodiment, the data analysis unit 111 analyzes data relating to the person's state of sleep including, but not limited to, the person's body position, body movement, breathing rate, heart rate, state of sleep, near-body temperature, near-body humidity, etc. The alarm control unit 117 then initiates an alarm using data provided by the data analysis unit 111. For example, according to one embodiment the alarm control unit 117 initiates an alarm when the person is at an optimal sleep state within a predetermined period during which the person desires to be awakened. Consistent with the present invention, a wide variety of alarms can be used, as discussed in detail below, and the present invention is not limited to any particular type of alarm.

According to an illustrative embodiment, a person inputs a desired awaken time (e.g., 7:00 AM) to the input unit 123. The person also inputs a desired awaken period within which the person desires to be awakened (e.g., ±5 minutes, ±15 minutes, ±30 minutes, etc.). By way of illustration, if the person inputs a desired awaken time of 7:00 AM and inputs a desired awaken period of ±15 minutes, then the data analysis unit 111 analyzes data relating to the person's state of sleep and provides the alarm control unit 117 with data regarding the optimal time to awaken the person between 6:45 AM and 7:15 AM. The alarm control unit 117 then initiates an alarm at the determined optimal awaken time so as to thereby awaken the person at the optimal state of sleep within the desired awaken period. However, the present invention is not limited to the aforementioned illustrative configuration and a wide variety of desired awaken times and desired awaken periods can be employed consistent with the present invention.

According to the above example, when the desired awaken period begins (e.g., 6:45 AM), the data analysis unit 111 analyzes data collected relating to the person's state of sleep. If the data analysis unit 111 determines that the person is in a deep state of sleep (e.g., State N4), then the alarm control unit 117 does not initiate an alarm at the beginning of the desired awaken period (e.g., 6:45 AM). Instead, the alarm control unit 117 continues to analyze data collected relating to the person's state of sleep until the data analysis unit 111 determines that the person is in a lighter state of sleep (e.g., State N1) before initiating the alarm. However, if the person does not experience a lighter state of sleep before the desired awaken period expires (e.g., by 7:15 AM), then the alarm control unit 117 initiates an alarm at the cutoff time of 7:15 AM. As a result, the person is generally awakened in a lighter state of sleep and, therefore, the awakening experience is much easier for the person and the possibility of tiredness or grogginess is reduced.

According to another example, when the desired awaken period begins (e.g., 6:45 AM), the data analysis unit 111 analyzes data collected relating to the person's state of sleep. If the data analysis unit 111 determines that the person is in a state of REM sleep, where most dream activity occurs, then the alarm control unit 117 does not initiate an alarm at the beginning of the desired awaken period (e.g., 6:45 AM). Rather, the alarm control unit 117 continues to analyze data collected relating to the person's state of sleep until the data analysis unit 111 determines that the person is in a non-REM (hereinafter “NREM”) sleep before initiating the alarm. However, if the person does not experience an NREM state of sleep before the desired awaken period expires (e.g., by 7:15 AM), then the alarm control unit 117 initiates an alarm at the cutoff time of 7:15 AM. In such a way, the person is generally awakened during a non-dreaming state of sleep and, thus, the possibility of confusion and disorientation is reduced and the awakening experience is more pleasant for the person.

Importantly, the present invention is not limited to the above illustrative configurations and a wide variety of apparatuses and methods for awakening a sleeping person based on the person's state of sleep fall within the scope of the present invention. For instance, according to one embodiment, the data analysis unit 111 analyzes data collected relating to the person's state of sleep over time and determines an optimal time to awaken the person within a desired awaken period using sleep state patterns exhibited by the person over time. As such, according to one example, the data analysis unit 111 analyzes data collected relating to the person's state of sleep just before the desired awaken period and determines that a person has periodically fluctuated between a deep state of sleep (e.g., State N4) and a lighter state of sleep (e.g., State N1). Using such data, the data analysis unit 111 determines when the next cycle of State N1 is likely to occur and the alarm control unit 117 initiates an alarm at the calculated optimal state of sleep within the desired awaken period.

Data relating to a person's state of sleep can be collected in a wide variety of ways using a wide variety of collection devices. As one example, data relating to a person's state of sleep can be collected by detecting the person's body movement. Generally speaking, if a person exhibits body movement, then the person is awake or in a lighter state of sleep. Therefore, by collecting data regarding the person's body movement, and by initiating an alarm when such movement occurs, the person may be awakened in a lighter state of sleep. Further, if the person is awake when such movement occurs, but not necessarily fully alert to their awakened state, such an alarm would, in effect, remind the person to awaken.

As one illustration of such devices that collect data relating to a person's state of sleep, according to an illustrative embodiment, data regarding a person's state of sleep is collected using a variable sleep system like that disclosed by the inventors of the present application in U.S. Provisional No. 61/028,591 entitled, “Apparatuses and Methods Providing Variable Support and Variable Comfort Control of a Sleep System and Automatic Adjustment Thereof,” which is incorporated herein by reference in its entirety. However, the present invention is not limited to including such a variable sleep system and a wide variety of sleep systems and apparatuses for collecting data regarding a person's state of sleep can be employed consistent with the present invention (a few examples of which are discussed in detail below).

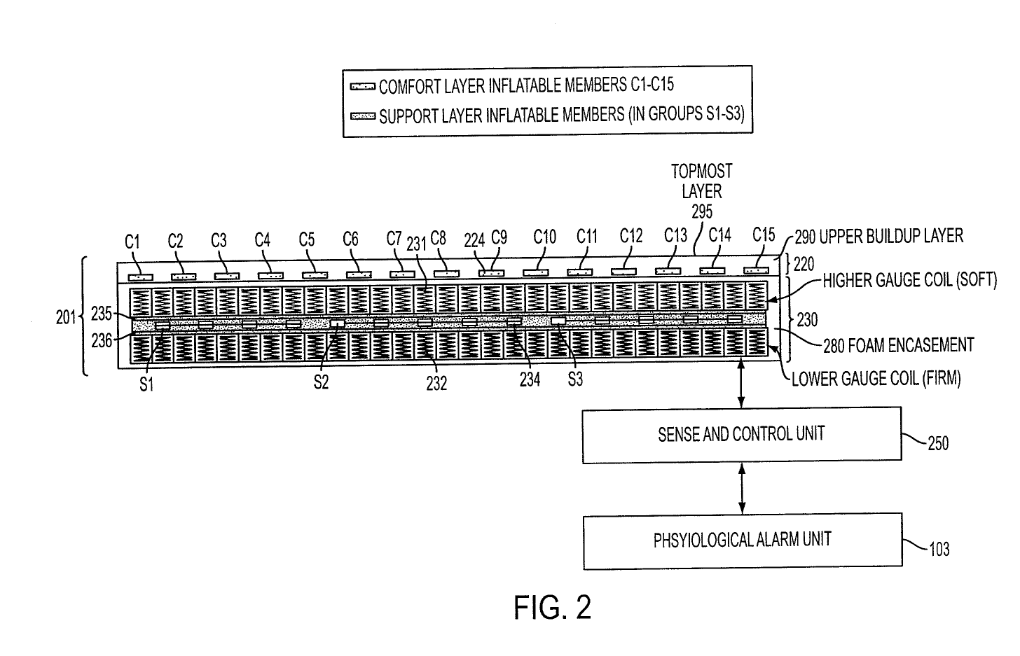

FIG. 2 illustrates a cross-sectional view of sleep system 201 employing a variable support and comfort control system according to an illustrative embodiment of the present invention. As shown in FIG. 2, a variable support and variable comfort sleep system 201 comprises a variable comfort layer 220 and a variable support layer 230 that is disposed below the variable comfort layer 220. The variable comfort layer 220 further comprises an upper buildup layer 290 and a topmost layer 295. Further, as shown in FIG. 2, the variable sleep system 201 is connected to a sense and control unit 250, which is in turn connected to the physiological alarm unit 103 described above.

By adjusting both the variable comfort layer 220 and the variable support layer 230, it is possible to adjust the variable sleep system 201 so that it provides the best possible combination of comfort and support to the person. Adjustments to the variable comfort layer 220 and the variable support layer 230 may be performed automatically based on body variances of the person, or manually based on the person's comfort and support preferences.

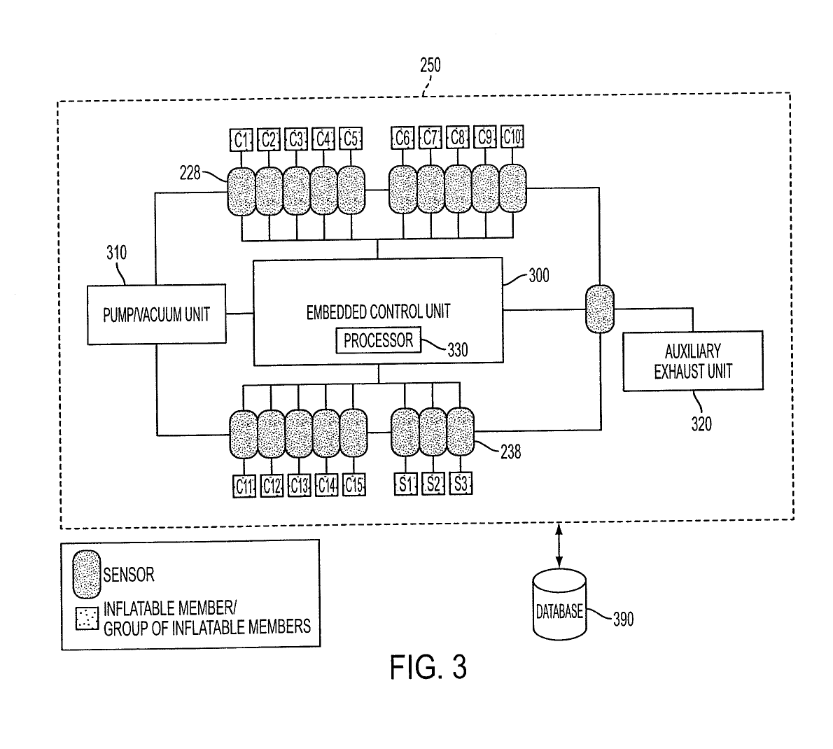

FIG. 2 shows an illustrative embodiment wherein the variable support layer 230 comprises a layer of upper coils 231 and a layer of lower coils 232. As shown in FIG. 2, the layer of upper coils 231 and the layer of lower coils 232 are enclosed by a foam encasement 280. A plurality of support layer inflatable members or bladders 234 are disposed between the layer of upper coils 231 and the layer of lower coils 232. As shown in FIG. 2, there are three groups of support layer inflatable members 234, which are respectively referenced as S1, S2 and S3. However, the present invention is not limited to the configuration shown in FIG. 2 and any number of groups of support layer inflatable members 234 may be employed. According to the illustrative embodiment shown in FIG. 2, the support layer inflatable members 234 are pneumatic and are connected to an optional pump/vacuum unit (shown in FIG. 3) via pneumatic tubes. However, the present invention is not limited to this illustrative configuration and other gasses or fluids may be employed to inflate/deflate the support layer inflatable members 234 to a desired pressure.

The support layer inflatable members 234 may be constructed of a variety of materials including, but not limited to plastic, vinyl, neoprene, rubber and the like. According to the illustrative embodiment shown in FIG. 2, the support layer inflatable members 234 extend in a lateral direction across the width of the variable sleep system 201, however, the present invention is not limited to this configuration and the support layer inflatable members 234 may be configured in any arrangement. For a sleep system designed to accommodate two people, such as a queen or king size bed, two sets of support layer inflatable members may be employed, each extending across the area in which one of the people would sleep.

As shown in FIG. 2, the support layer inflatable members 234 are configured such that, when inflated, the support layer inflatable members 234 apply forces to the layer of upper coils 231 and to the layer of lower coils 232. Accordingly, by controlling the inflation/deflation of the support layer inflatable members 234, the support characteristics of the variable sleep system 201 can be adjusted.

As shown in FIG. 2, the variable sleep system 201 is connected to a sense and control unit 250, which is in turn connected to the physiological alarm unit 103. However, the present invention is not limited to the illustrative configuration shown in FIG. 2 and, according to one illustrative embodiment, the physiological alarm unit 103 is integrated into the sense and control unit 250. More generally, the physiological alarm unit 103 may be integrated into any aspect of the variable sleep system 201 or any aspect of the person's sleeping environment consistent with the present invention.

A detailed illustration of an illustrative sense and control unit 250 is shown in FIG. 3. As shown in FIG. 3, the sense and control unit 250 comprises a plurality of comfort layer sensors 228, which are respectively associated with the comfort layer inflatable members 224, which are respectively referenced as C1, C2, C3, C4, C5, C6, C7, C8, C9, C10, C11, C12, C13, C14 and C15. The sense and control unit 250 further comprises a plurality of support layer sensors 238, which are respectively associated with the groups S1, S2 and S3 of support layer inflatable members 234. As further illustrated in FIG. 3, the sense and control unit 250 comprises an embedded control unit 300, a pump/vacuum unit 310 and an auxiliary exhaust unit 320. The embedded control unit comprises a processor 330, a memory (volatile or non-volatile), a communication bus, and an input/output unit (not shown). According to the illustrative embodiment shown in FIG. 3, the sense and control unit 250 is connected to a database 390 that can be integrated with the embedded control unit 300 or can be external thereto.

As shown in FIGS. 2 and 3, each of the plurality of support layer sensors 238 are connected to a respective group of the support layer inflatable members 234. Each of the support layer sensors 238 is configured to provide real time measurements relating to the pressure of a respective support layer inflatable member 234 or a respective group of support layer inflatable members 234.

Moreover, as shown in FIG. 2, a first force dispersing cover 235 may be disposed between the support layer inflatable members 234 and the coils of the layer of upper coils 231. Likewise, a second force dispersing cover 236 may be disposed between the support layer inflatable members 234 and the layer of lower coils 232.

As shown in FIG. 2, an upper buildup layer 290 is disposed above the layer of upper coils 231. The upper buildup layer 290 comprises a plurality of comfort layer inflatable members 224 that are disposed above the layer of upper coils 231 and below a topmost layer 295. The configuration of each of the respective comfort layer inflatable members 224 is similar to the configuration of the support layer inflatable members 234, discussed above.

Consistent with the illustrative embodiment depicted in FIG. 2, the comfort layer inflatable members 224 are configured such that, when inflated, the comfort layer inflatable members 224 apply forces to the layer of upper coils 231, to the upper buildup layer 290 and to the topmost layer 295. By controlling the inflation/deflation of the comfort layer inflatable members 224, the comfort characteristics of the variable sleep system 201 (among other things) can be adjusted.

Additionally, as shown in FIGS. 2 and 3, each of a plurality of comfort layer sensors 228 are connected to a respective one of the comfort layer inflatable members 224. Each of the comfort layer sensors 228 is configured to provide real time measurements relating to the pressure of a respective comfort layer inflatable member 224.

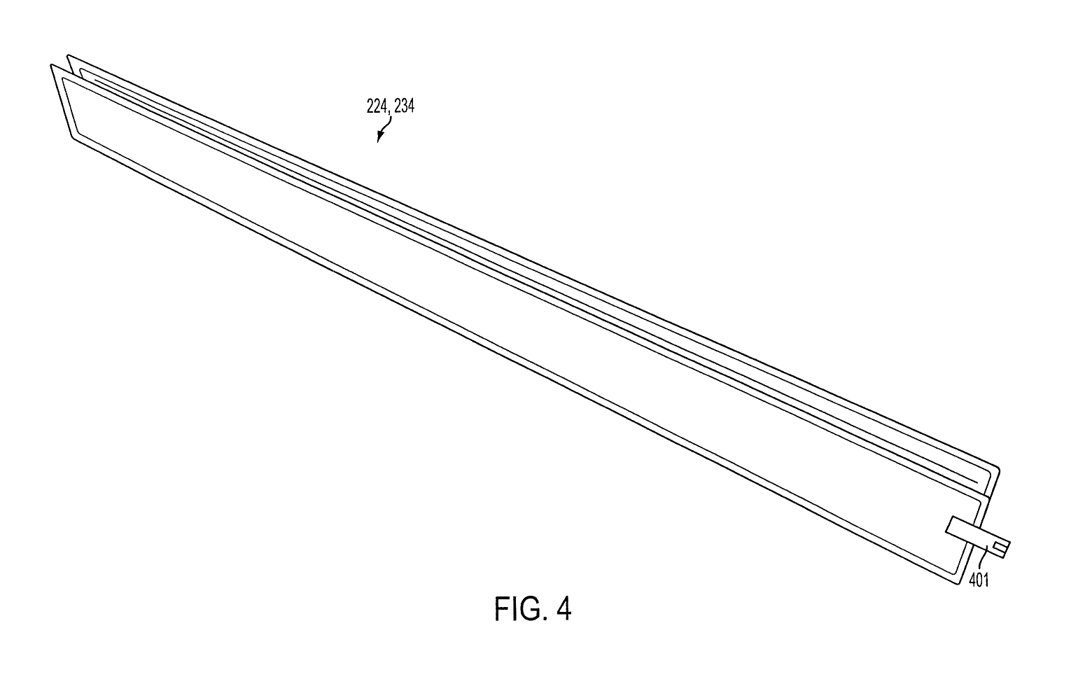

FIG. 4 illustrates a view of an inflatable member 224 or 234 according to an illustrative embodiment of the present invention. Although one illustrative shape and configuration of the inflatable member is shown in FIG. 4, the inflatable members 224 and 234 may assume other shapes and configurations consistent with the present invention. Further, the comfort layer inflatable members 224 may assume shapes and/or configurations that are different from the shapes and/or configurations of the support layer inflatable members 234. As shown in FIG. 4, each of the inflatable members comprises a valve 401.

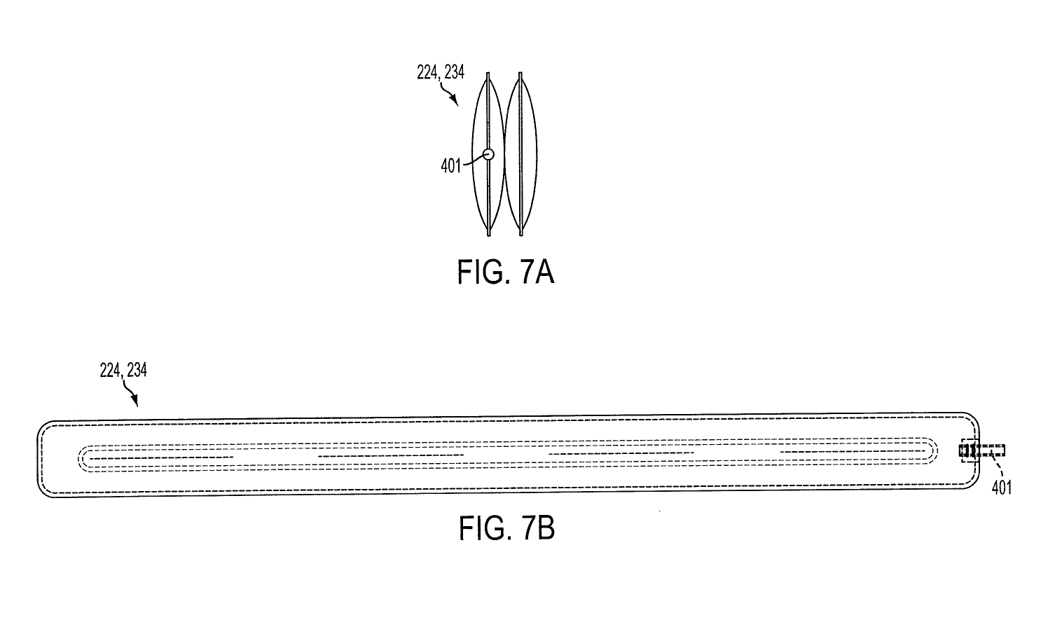

FIG. 7A illustrates a side view of one end of an inflatable member 224 or 234 according to an illustrative embodiment of the present invention. FIG. 7B illustrates a top view of an inflatable member 224 or 234 according to an illustrative embodiment of the present invention.

The support layer sensors 238 and the comfort layer sensors 228 provide the ability to measure a wide variety of data. For example, when a person is positioned on the variable sleep system 201, data provided by the support layer sensors 238 and the comfort layer sensors 228 can be analyzed to determine, among other things, the person's weight, weight distribution, body position, body movement, breathing rate, heart rate, state of sleep, etc. Further, such data can be acquired and analyzed over time by the sense and control unit 250 to determine a variety of body variances and sleep state variances of the person while the person is positioned on the variable sleep system 201.

According to an illustrative embodiment of the present invention, data collected by the sense and control unit 250 relating to the person's state of sleep is provided to the physiological alarm unit 103. For instance, according to one embodiment, data provided by the support layer sensors 238 and the comfort layer sensors 228 is processed by the processor 330 using various algorithms to produce data relating to the person's state of sleep including, but not limited to, the person's body movement, breathing rate, heart rate, etc. The sense and control unit 250 then provides data relating to the person's state of sleep to the physiological alarm unit 103. The data analysis unit 111 analyzes this data relating to the person's state of sleep and the alarm control unit 117 initiates an alarm using data provided by the data analysis unit 111, as described in detail above.

However, the above embodiments are merely examples and the present invention may comprise many different configurations. For example, according to one embodiment, the data analysis unit 111 is incorporated into the sense and control unit 250. According to another illustrative embodiment, the alarm control unit 117 is incorporated into the sense and control unit 250. According to another embodiment, the input unit 123 is incorporated into the sense and control unit 250. Indeed, according to one embodiment of the present invention, the entire physiological alarm unit 103 is incorporated into the sense and control unit 250 so that a separate standalone unit is not required.

Importantly, the present invention is not limited to the aforementioned illustrative embodiments and data relating to a person's state of sleep can be collected in a wide variety of ways other using a wide variety of collection devices other than those described above. For instance, according to another illustrative embodiment, data relating to a person's state of sleep can be collected using an automatic pillow adjustment system like that disclosed by the inventors of the present application in U.S. Provisional No. 61/028,572 entitled “Automatic Pillow Adjustment System,” which is incorporated herein by reference in its entirety. However, the present invention does not require use of such an automatic pillow adjustment system and illustrative embodiments of the present invention employ conventional adjustable and non-adjustable pillow systems.

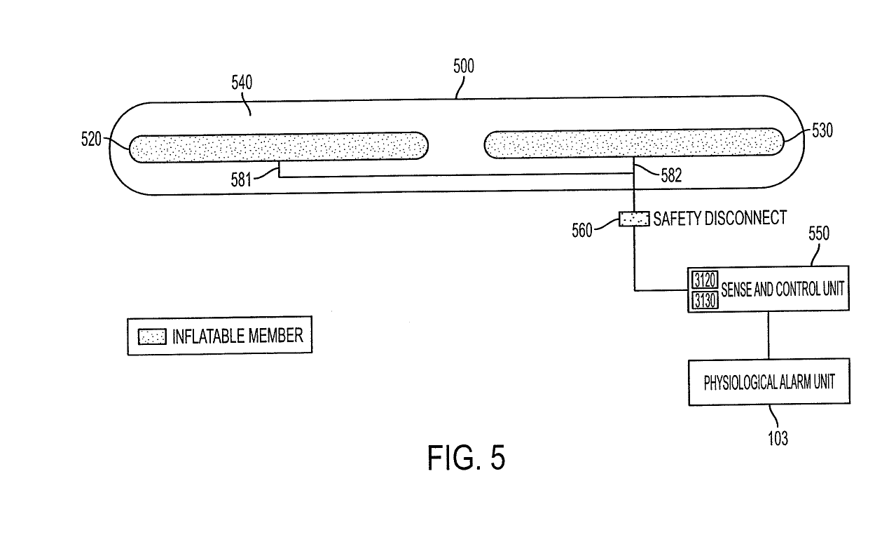

FIG. 5 illustrates a schematic cross-sectional view of an automatic pillow adjustment system according to an illustrative embodiment of the present invention. As shown in FIG. 5, an adjustable head support member 500 comprises a first inflatable member or bladder 520 and a second inflatable member 530, which are both surrounded by an encasement layer 540. According to an illustrative embodiment, the configurations of the inflatable members 520 and 530 are similar to the configurations of the support layer inflatable members 234 and comfort layer inflatable members 224, discussed above, each with a length suitable for use in a pillow.

As shown in FIG. 5, a sense and control unit 550 is disposed external to the adjustable head support member 500 and the inflatable members 520 and 530 are connected to the sense and control unit 550 by pneumatic tubes 581 and 582. As shown in FIG. 5, a safety disconnect unit 560 may be disposed between the inflatable members 520 and 530 and the sense and control unit 550. The safety disconnect unit 560 is configured such that, in case of entanglement, the safety disconnect unit 560 will allow the adjustable head support member 500 to come free from the sense and control unit 550. As shown in FIG. 5, the sense and control unit 550, in turn, is connected to the physiological alarm unit 103.

According to the illustrative embodiment shown in FIG. 5, the inflatable members 520 and 530 extend in a lateral direction across the width of the adjustable head support member 500. Further, as shown in FIG. 5, the inflatable members 520 and 530 are configured such that, when inflated, the inflatable members 520 and 530 expand and thereby apply forces to the encasement layer 540, which (among other things) supports the weight of the head and neck region of a person's body. Accordingly, by controlling the inflation/deflation of the inflatable members 520 and 530, the support characteristics of the adjustable head support member 500 can be adjusted.

As shown in FIG. 5, the illustrative sense and control unit 550 comprises a first sensor 3120, which is connected to inflatable member 520, and a second sensor 3130, which is connected to inflatable member 530. According to the illustrative embodiment shown in FIG. 5, the sensor 3120 provides real time measurements relating to the pressure of inflatable member 520 and, likewise, the sensor 3130 provides real time measurements relating to the pressure of inflatable member 530. As such, when a person positions their head on the adjustable head support member 500, measurements relating to the pressure of respective inflatable members 520 and 530 can be acquired and analyzed. Using such measurements, a support pressure profile of the person can be obtained and used to determine the most suitable pillow support characteristics for the person.

Consistent with the present invention, the sensors 3120 and 3130, together with the inflatable members 520 and 530, provide the ability to measure a wide variety of data. For example, when a person is positioned with their head on the adjustable head support member 500, data provided by the sensors 3120 and 3130 can be analyzed to determine, among other things, the weight applied by the person to the adjustable head support member 500, the distribution of such weight, the person's body position, the person's body movement, the person's breathing rate, the person's heart rate, the person's state of sleep, etc. Accordingly, by analyzing the data collected by the sensors 3120 and 3130 over time, the sleeping position of the person can be determined and the pressures of the inflatable members 520 and 530 can be controlled so that the adjustable head support member 500 provides the optimal support characteristics for the person.

According to an embodiment of the present invention, data collected by the sense and control unit 550 relating to the person's state of sleep is provided to the physiological alarm unit 103. For instance, according to one embodiment, data provided by the sensors 3120 and 3130 is processed by the sense and control unit 550 using various algorithms to produce data relating to the person's state of sleep including, but not limited to, the person's body movement, breathing rate, heart rate, etc. The sense control unit 550 then provides data relating to the person's state of sleep to the physiological alarm unit 103. The data analysis unit 111 analyzes this data relating to the person's state of sleep, and the alarm control unit 117 initiates an alarm using data provided by the data analysis unit 111, as described in detail above.

However, the above embodiments are merely examples and the present invention may comprise many different configurations. For example, according to one embodiment, the data analysis unit 111 is incorporated into the sense and control unit 550. According to another illustrative embodiment, the alarm control unit 117 is incorporated into the sense and control unit 550. According to another embodiment, the input unit 123 is incorporated into the sense and control unit 550. Indeed, according to one embodiment of the present invention, the entire physiological alarm unit 103 is incorporated into the sense and control unit 550 so that a separate standalone unit is not required.

According to another illustrative embodiment, data relating to a person's state of sleep can be collected using a near-body sensing device that, for example, may be worn on the wrist of a person positioned on the sleep system 201. An example of such a near-body sensing device is disclosed by the inventors of the present application in U.S. Provisional No. 61/031,235 entitled “Systems and Methods for Controlling a Bedroom Environment,” which is incorporated herein by reference in its entirety. However, the present invention does not require use of such a near-body sensing device.

As a non-limiting example, the near-body sensing device may comprise an Actiwatch® manufactured by Mini Mitter, which is an actigraphy device that is the size of a standard wrist watch. An Actiwatch® is equipped with a highly sensitive accelerometer, which records movement data that can be used to measure and analyze sleep quality of a person wearing the Actiwatch®.

However, the present invention is not limited to a configuration wherein the near-body sensing device is worn on a person's wrist, and embodiments of the present invention may comprise near-body sensing device(s) that is/are worn on any part of a person's body, or multiple parts of a person's body. Illustrative embodiments may also comprise near-body sensing device(s) that is/are integrated into aspect(s) of the bedding assembly including, but not limited to, a mattress, a bed frame, a pillow, a mattress pad, and/or linens of the sleep system 201. Alternatively, the near-body sensing device(s) can be integrated into clothes in which the person sleeps, such as in pajamas.

The near-body sensing device can collect a wide variety of data relating to the person's state of sleep including, but not limited to, the person's body position, body movement, breathing rate, heart rate, state of sleep, near-body temperature, near-body humidity, etc., of a person disposed on the sleep system 201. The near-body sensing device may be configured to transmit collected data to the physiological alarm unit 103 via a wide variety of wired or wireless connections. The data analysis unit 111 then analyzes this data relating to the person's state of sleep, and the alarm control unit 117 initiates an alarm using data provided by the data analysis unit 111, as described in detail above.

According to another embodiment of the present invention, the physiological alarm unit 103 may be incorporated into the controller described the related U.S. Provisional No. 61/031,235, “Systems and Methods for Controlling a Bedroom Environment.”

Consistent with the present invention, the alarm control unit 117 may awaken a person based on the person's sleep state in a wide variety of different ways so as to improve the person's awakening experience. According to one embodiment, using data provided by the data analysis unit 111, the alarm control unit 117 initiates an audible alarm, such as a buzzer or a ringing tone. According to one embodiment, the volume of the buzzer or ringing tone is initially barely audible and then gradually increases over time so that the buzzer or ringing tone does not startle the person.

Further, in one illustrative embodiment, using data provided by the data analysis unit 111, the alarm control unit 117 initiates oscillation of the support layer inflatable members 234, and/or the comfort layer inflatable members 224, and/or the first inflatable member 520, and/or the second inflatable member 530 so as to awaken the person. Initially, such oscillation may be small in magnitude and barely noticeable by the person. Then, the oscillation may gradually increase in magnitude over time so as to gently awaken the person.

According to another embodiment, using data provided by the data analysis unit 111, the alarm control unit 117 controls a light in the bedroom in which the person is sleeping to turn ON in order to awaken the person. Initially, the intensity of the light may be barely visible to the human eye and the intensity of the light may be increased gradually so as to awaken the person in a pleasing manner. To this effect, the alarm control unit 117 may interface with the lighting system through a variety of wired and wireless means.

According to one embodiment, the alarm control unit 117 interfaces with the controller disclosed in U.S. Provisional No. 61/031,235, “Systems and Methods for Controlling a Bedroom Environment,” so as to adjust any bedroom device in such a way to awaken the person.

According to one illustrative embodiment, using data provided by the data analysis unit 111, the alarm control unit 117 adjusts the comfort layer inflatable members 224 in a manner so as to awaken the person. For instance, the alarm control unit 117 may adjust the comfort layer inflatable members 224 so as to decrease the comfort level provided by the sleep system 201 and thereby awaken the person.

In another illustrative embodiment, sound producing devices may be incorporated into the sleep system 201. Such sound devices may include, but are not limited to, audio speakers connected to a radio device, a digital media device, an analog media device, television, etc. The sound producing devices may be incorporated into any aspect of the sleep system 201, including, but not limited to a sleep support member, a mattress, pillow, headboard, etc. Thus, in one embodiment, using data provided by the data analysis unit 111, the alarm control unit 117 adjusts the sound producing devices to produce sounds so as to awaken the person. According to one embodiment, the volume of the sound producing devices is initially barely audible and then gradually increases over time so that the sound producing devices gently awaken the person without startling the person. Further, the alarm control unit 117 may control the sound producing devices to awaken the person with soft music, soothing nature sounds, etc. so that the person awakens in a pleasant manner.

According to another illustrative embodiment, massaging units may be incorporated into the sleep system 201. Using data provided by the data analysis unit 111, the alarm control unit 117 may control the massaging units to massage the person disposed on the sleep system 201 so as to awaken the person in a gentle and soothing manner.

In yet another illustrative embodiment, the sleep system 201, is connected to a sleep system temperature adjustment unit and/or a sleep system humidity adjustment unit. The sleep system temperature adjustment unit may include a wide variety of conventional heating and cooling mechanisms. For example, the sleep system temperature adjustment unit may comprise a heating pad configured to heat a surface of the sleep system 201 and/or an area surrounding the sleep system 201. Additionally, the sleep system temperature adjustment unit may comprise a cooling fan, or a fluid cooling mechanism integrated into the sleep system 201, configured to cool the area surrounding the sleep system 201. Likewise, the sleep system humidity adjustment unit may comprise a wide variety of conventional humidity control mechanisms that are configured to increase or decrease the relative humidity of the area surrounding the sleep system 201. Such heating, cooling and humidity adjustments can be controlled, for example, using conventional control units like those developed by Logicdata® such as the LogicData FLEX-5M-5.7.4.KD. As such, in one embodiment, using data provided by the data analysis unit 111, the alarm control unit 117 adjusts the sleep system temperature adjustment unit and the sleep system humidity adjustment unit so as to awaken the person.

Importantly, the present invention is not limited to any of the above-mentioned alarm mechanisms, and embodiments of the present invention may employ other alarm mechanisms not specifically mentioned above. Further, embodiments of the present invention may employ any combination of alarm mechanisms. For instance, according to one embodiment, using data provided by the data analysis unit 111, the alarm control unit 117 first initiates subtle alarms such as gentle oscillation of the comfort layer inflatable members 224. Then, if the data analysis unit 111 determines that the person has not yet fully awakened, then the alarm control unit 117 controls the sound producing units to produce soothing nature sounds at gradually increasing volume levels. Finally, if the data analysis unit 111 determines that the person still has not yet fully awakened, the alarm control unit 117 controls a loud buzzer or ringing tone to awaken the person.

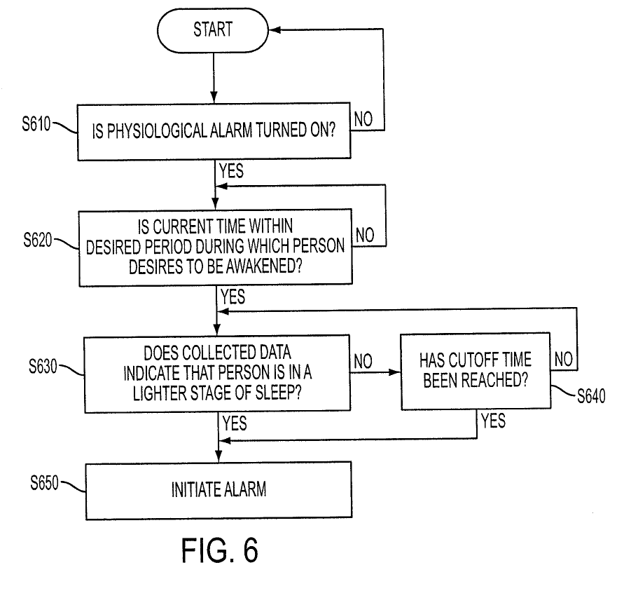

FIG. 6 illustrates a flow chart of a method for a physiological alarm according to an illustrative embodiment of the present invention. As shown in FIG. 6, in operation 5610, first, it is determined whether the physiological alarm feature is activated. If it is determined that the physiological alarm feature is not activated, then operation 5610 is performed. On the other hand, if it is determined that the physiological alarm feature is activated, then operation S620 is performed.

In operation 5620, it is determined whether the current time is within the desired period during which the person desires to be awakened. If it is determined that the current time is not within the desired awaken period, then operation S620 is performed. However, if it is determined that the current time is within the desired period during which the person desires to be awakened, then operation S630 is performed.

In operation 5630, collected data relating to the person's state of sleep is analyzed and it is determined whether such data indicates that the person is in a lighter state of sleep (e.g., State N1). If, in operation 5630, it is determined that the collected data indicates that the person is in a lighter state of sleep, then operation S650 is performed wherein an alarm is initiated to awaken the person. On the other hand, if it is determined that the collected data indicates that the person is not in a lighter state of sleep, then operation S640 is performed.

In operation S640, it is determined whether the cutoff time (i.e., the end of the desired awaken period) has been reached. If so, then operation 5650 is performed wherein an alarm is initiated to awaken the person. However, if it is determined that the cutoff time has not been reached, then operation 5630 is performed.

The methods for a physiological alarm according to illustrative embodiments of the present invention can also be embodied as computer readable codes on a computer readable recording medium. The computer readable recording medium can be any data storage device that can store data which can be read by a computer or a computer system. Examples of the computer readable recording medium include, but are not limited to, read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

While the present invention has been particularly shown and described with reference to illustrative embodiments thereof, it will be understood by those of ordinary skill in the art that various changes in form and details may be made therein without departing from the spirit and scope of the invention as defined by the appended claims. The illustrative embodiments should be considered in a descriptive sense only and not for purposes of limitation. Therefore, the scope of the invention is defined not by the detailed description of the invention but by the claims set forth in the related non-provisional application and all differences within the scope will be construed as being included in the present invention.

What is claimed is:

1. An alarm apparatus comprising:
a data analysis unit;
an input unit; and
an alarm control unit;
wherein the data analysis unit is configured to analyze data related to a state of sleep of a person;
wherein the input unit is configured to input data related to a desired awaken period within which the person desires to be awakened; and
wherein the alarm control unit is configured to control an alarm for awakening the person using information from the data analysis unit.

2. The alarm apparatus according to claim 1, wherein the alarm apparatus is incorporated into a standalone unit.

3. The alarm apparatus according to claim 1, wherein the data analysis unit is configured to analyze data relating to at least one of body movement of the person, breathing rate of the person, heart rate of the person and state of sleep of the person.

4. The alarm apparatus according to claim 3, wherein the data analysis unit is configured to analyze data relating to at least one of body position of the person, near-body temperature of the person and near-body humidity of the person.

5. The alarm apparatus according to claim 1, wherein the data analysis unit is configured to determine an optimal sleep state of the person within the desired awaken period; and
wherein the alarm control unit is configured to initiate an alarm when the data analysis unit determines that the person is at the optimal sleep state.

6. The alarm apparatus according to claim 1, wherein the data analysis unit is configured to determine whether data indicates that the person is in a deep state of sleep within the desired awaken period;
wherein the alarm control unit is configured such that, if the data analysis unit determines that data indicates that the person is in a deep state of sleep within the desired awaken period, then the alarm control unit delays initiating the alarm until either the data analysis unit determines that data indicates that the person is in a lighter state of sleep or the desired awaken period expires.

7. The alarm apparatus according to claim 1, wherein the data analysis unit is configured to determine whether data indicates that the person is in a state of REM sleep within the desired awaken period;
wherein the alarm control unit is configured such that, if the data analysis unit determines that data indicates that the person is in a state of REM sleep within the desired awaken period, then the alarm control unit delays initiating the alarm until either the data analysis unit determines that data indicates that the person is in a state of non-REM sleep or the desired awaken period expires.

8. The alarm apparatus according to claim 1, further comprising a sleep data collection unit configured to collect data related to a state of sleep of the person.

9. The alarm apparatus according to claim 5, wherein the data analysis unit is configured to determine the optimal sleep state of the person using sleep state patterns exhibited by the person over time.

10. The alarm apparatus according to claim 8, wherein the sleep data collection unit collects data using a variable sleep system.

11. The alarm apparatus according to claim 1, wherein the alarm apparatus is integral with a mattress.

12. The alarm apparatus according to claim 8, wherein the sleep data collection unit collects data using a head support member.

13. The alarm apparatus according to claim 8, wherein the sleep data collection unit collects data using a near-body sensor.

14. The alarm apparatus according to claim 1, wherein the alarm control unit is configured to control an audible alarm.

15. The alarm apparatus according to claim 1, wherein the alarm control unit is configured to control movement of at least one of a mattress and a pillow.

16. The alarm apparatus according to claim 1, wherein the alarm control unit is configured to control a lighting device.

17. The alarm apparatus according to claim 1, wherein the alarm control unit is configured to control at least one of a temperature of a sleep system and a humidity of the sleep system.

18. A method for awakening a person, the method comprising:
inputting a desired awaken period within which the person desires to be awakened;
determining whether a current time is within the desired awaken period;
if it is determined that the current time is within the desired awaken period, then executing an analysis method comprising:
analyzing data relating to the person's state of sleep;
determining whether the analyzed data indicates that the person is in a light stage of sleep;
if it is determined that the analyzed data indicates that the person is in a light stage of sleep, then initiating an alarm process;
if it is determined that the analyzed data does not indicate that the person is in a light stage of sleep, then determining whether the desired awaken period has expired;
if it is determined that the desired awaken period has expired, then initiating the alarm process.

19. The method for awakening a person according to claim 18, wherein the analyzing data relating to the person's state of sleep comprises analyzing data relating to at least one of body movement of the person, breathing rate of the person, heart rate of the person and state of sleep of the person.

20. The method for awakening a person according to claim 18, wherein the analyzing data relating to the person's state of sleep comprises analyzing data relating to at least one of body position of the person, near-body temperature of the person and near-body humidity of the person.

21. The method for awakening a person according to claim 18, further comprising:
determining an optimal sleep state of the person within the desired awaken period; and
initiating an alarm when it is determined that the person is at the optimal sleep state.

22. The method for awakening a person according to claim 18, further comprising:
determining whether data indicates that the person is in a deep state of sleep within the desired awaken period; and
if it is determined that data indicates that the person is in a deep state of sleep within the desired awaken period, then delaying initiation of the alarm until either it is determined that data indicates that the person is in a light state of sleep or the desired awaken period expires.

23. The method for awakening a person according to claim 18, further comprising:
determining whether data indicates that the person is in a state of REM sleep within the desired awaken period; and
if it is determined that data indicates that the person is in a state of REM sleep within the desired awaken period, then delaying initiation of the alarm until either the data analysis unit determines that data indicates that the person is in a state of non-REM sleep or the desired awaken period expires.

24. The method for awakening a person according to claim 21, further comprising determining the optimal sleep state of the person using sleep state patterns exhibited by the person over time.

25. The method for awakening a person according to claim 18, wherein the alarm process comprises controlling an audible alarm.

26. The method for awakening a person according to claim 18, wherein the alarm process comprises controlling movement of at least one of a mattress and a pillow.

27. The method for awakening a person according to claim 18, wherein the alarm process comprises controlling a lighting device.

28. The method for awakening a person according to claim 18, wherein the alarm process comprises controlling at least one of a temperature of a sleep system and a humidity of the sleep system.
